(19) United States
(12) Patent Application Publication
(10) Pub. No.: US 2003/0187704 A1
(43) Pub. Date: Oct. 2, 2003

(54) Method of and apparatus for setting insurance premium, and computer product

(75) Inventors: Norio Hashiguchi, Kawasaki (JP); Tomonobu Takashima, Kawasaki (JP); Tadao Omi, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/270,202

(22) Filed: Oct. 15, 2002

(30) Foreign Application Priority Data
Mar. 26, 2002 (JP) 2002-086703

(51) Int. Cl. G06F 17/60

(52) U.S. Cl. 705/4

(57) ABSTRACT

Information about a driver of a vehicle is received from the vehicle. A driving response estimating section estimates any one or both of driving response and behavior recommendable to the driver. The estimated information for driving response and behavior is transmitted to the vehicle. Another information about the driver after transmission of the estimated driving response and behavior information to the driver is received. A comparing section compares the received information with the estimated driving response and behavior information. An insurance premium setting section sets a premium to the driver.

### BACKGROUND OF THE INVENTION

1) Field of the Invention

The present invention relates to an insurance premium setting method, an insurance premium setting program, an insurance premium setting apparatus, and an insurance premium setting terminal unit which set damage insurance premiums of automobile insurance or the like.

2) Description of the Related Art

Conventionally, premiums of damage insurance, particularly, automobile insurance have been set in various ways. For example, a premium has been set to a vehicle owned by a driver. A daily premium has been calculated based on an operation status of a driver who owns a vehicle to set a total premium from the accumulation of the daily premiums. Alternatively, a driver has set a target value by himself or herself for safe driving, and a part of the premium has been refunded from an insurance company according to the driving effort made to achieve the target.

However, according to the conventional setting methods, all drivers are to pay equal premiums, regardless of whether a driver daily uses a vehicle for commutation or a driver is a paper driver. This has had a problem of unfairness in the payment of premiums when the frequency of meeting accidents is taken into account.

A driver may meet accidents due to the driving behavior of the driver by himself or herself, or the driver may be involved in accidents that have been made by other vehicles. Therefore, there are many opportunities that drivers meet accidents even if they keep safe driving. If drivers can know such risk information in advance, they can prevent involvement in accidents, and it is possible to avoid increase in the premium due to the accidents. So far, insurance companies have not set premiums by taking such information into account, despite the fact that they can suppress payment of huge amount of insurance money due to accidents.

### SUMMARY OF THE INVENTION

It is an object of the present invention to provide an insurance premium setting method, an insurance premium setting program, an insurance premium setting apparatus, and an insurance premium setting terminal unit which can decrease the number of occurrence of accidents, can thereby decrease the amount of premiums paid by insured persons and the amount of insurance money paid by the insurance companies, and can set optimum premiums for the insured persons.

According to one aspect of the invention, there are provided the insurance premium setting method, the insurance premium setting program, and the insurance premium setting apparatus that execute the following respectively. At least either one of driving information of a vehicle driver and position information that shows a position of the vehicle is obtained. Any one or both of driving response and behavior recommendable to the driver are estimated based on at least either one of the obtained driving information and the position information. A warning is given to the driver based on the information relating to the estimated driving response and behavior. Driving information for the driver after the driver has been warned is obtained. The obtained driving information is compared with the information relating to the driving response and behavior estimated at the driving response estimating step. Then, an insurance premium of the driver is set based on a result obtained by the comparison.

According to another aspect of the invention, there are provided the insurance premium setting method, the insurance premium setting program, and the insurance premium setting apparatus that execute the following respectively. At least either one of driving information of a vehicle driver and position information that shows a position of the vehicle is obtained from the vehicle. Any one or both of driving response and behavior recommendable to the driver are estimated based on at least either one of the received driving information and the position information. The estimated information relating to the driving response and behavior is transmitted to the vehicle. Driving information for the driver after the information relating to the driving response and behavior has been transmitted to the vehicle at the transmitting step, is received from the vehicle. The received driving information is compared with the information relating to the driving response and behavior estimated at the driving response estimating step. An insurance premium of the driver is set based on a result obtained by the comparison.

According to the above aspects of the invention, a warning is first given to a driver on a driving status that is estimated to bring about an accident, and then an insurance premium can be set to this driver based on any one or both of driver's response and behavior to the warning. When the driver responses and behaves undesirably to the warning, the insurance premium is increased, and when the driver responses and behaves desirably to the warning, the insurance premium is decreased.

These and other objects, features and advantages of the present invention are specifically set forth in or will become apparent from the following detailed descriptions of the invention when read in conjunction with the accompanying drawings.

### BRIEF DESCRIPTION OF THE DRAWINGS

FIG. 1 is a system structure diagram of an insurance premium setting system that includes an insurance premium setting apparatus and an insurance premium setting terminal unit according to an embodiment of the present invention,

FIG. 2 is a block diagram which shows one example of a hardware structure of a vehicle-installed terminal unit 102 as the insurance premium setting terminal unit according to the embodiment of the present invention,

FIG. 3 is a block diagram which shows one example of a hardware structure of a management server 101 as the insurance premium setting apparatus according to the embodiment of the present invention,

FIG. 4 is a block diagram which shows one example of a functional structure of the vehicle-installed terminal unit 102 as the insurance premium setting terminal unit according to the embodiment of the present invention,

FIG. 5 is a block diagram which shows one example of a functional structure of the management server 101 as the insurance premium setting apparatus according to the embodiment of the present invention,

FIG. 6 is an explanatory diagram which shows contents of an individual database 400 that is held by the vehicle-installed terminal unit 102 as the insurance premium setting terminal unit according to the embodiment of the present invention,

FIG. 7 is an explanatory diagram which shows contents of an individual database 500 that is held by the management server 101 as the insurance premium setting apparatus according to the embodiment of the present invention,

FIG. 8 is an explanatory diagram which shows detailed contents of the individual databases 400 and 500,

FIG. 9 is an explanatory diagram which shows contents of a vehicle movement management database 510 held by the management server 101 as the insurance premium setting apparatus according to the embodiment of the present invention,

FIG. 10 is an explanatory diagram which shows contents of an status-base instruction/recommendation table 520 held by the management server 101 as the insurance premium setting apparatus according to the embodiment of the present invention,

FIG. 11 is an explanatory diagram which shows contents of an insurance premium calculation table 530 held by the management server 101 as the insurance premium setting apparatus according to the embodiment of the present invention,

FIG. 12 is a flowchart which shows steps of the processing in the vehicle-installed terminal unit 102 as the insurance premium setting terminal unit according to the embodiment of the present invention, and

FIG. 13 is a flowchart which shows steps of the processing in the management server 101 as the insurance premium setting apparatus according to the embodiment of the present invention.

### DETAILED DESCRIPTION

Embodiments of the insurance premium setting method, the insurance premium setting program, the insurance premium setting apparatus, and the insurance premium setting terminal unit according to the present invention will be explained in detail below with reference to the attached drawings.

[System Structure of an Insurance Premium Setting System]

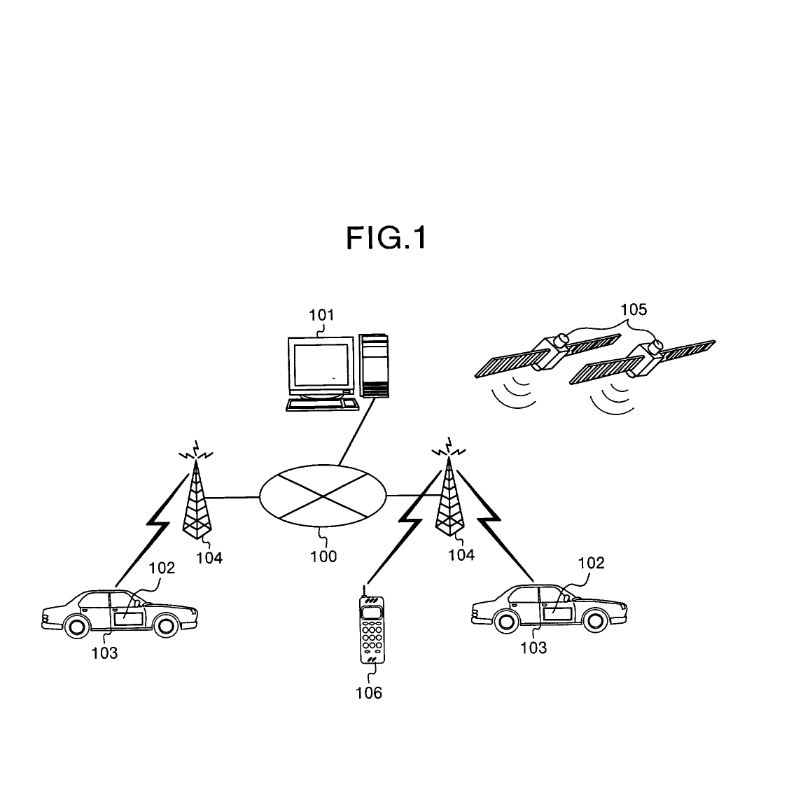

The system structure of an insurance premium setting system that includes an insurance premium setting apparatus and an insurance premium setting terminal unit according to an embodiment of the present invention will be explained first. FIG. 1 is a system structure diagram of the insurance premium setting system according to the embodiment of the present invention.

In FIG. 1, a reference numeral 100 denotes a network such as the Internet, 101 denotes a management server 101 as the insurance premium setting apparatus, and 102 denotes a vehicle-installed terminal unit as the insurance premium setting apparatus or the insurance premium setting terminal unit installed in a vehicle 103. A reference numeral 104 denotes a relay station (radio base station) that carries out radio communications with the vehicle-installed terminal unit 102. A reference numeral 105 denotes a plurality of (usually three or four) global positioning system (GPS) satellites that specify a position of the vehicle 103. A reference numeral 106 denotes a portable telephone set (including a personal digital assistant (PDA)) as the insurance premium setting terminal unit.

The management server 101 and the vehicle-installed terminal unit 102 are connected to each other by the network 100 via the relay station (radio base station) 104. The insurance premium setting system is composed of the management server 101 and the vehicle-installed terminal unit 102.

[Hardware Structure of the Vehicle-Installed Terminal Unit]

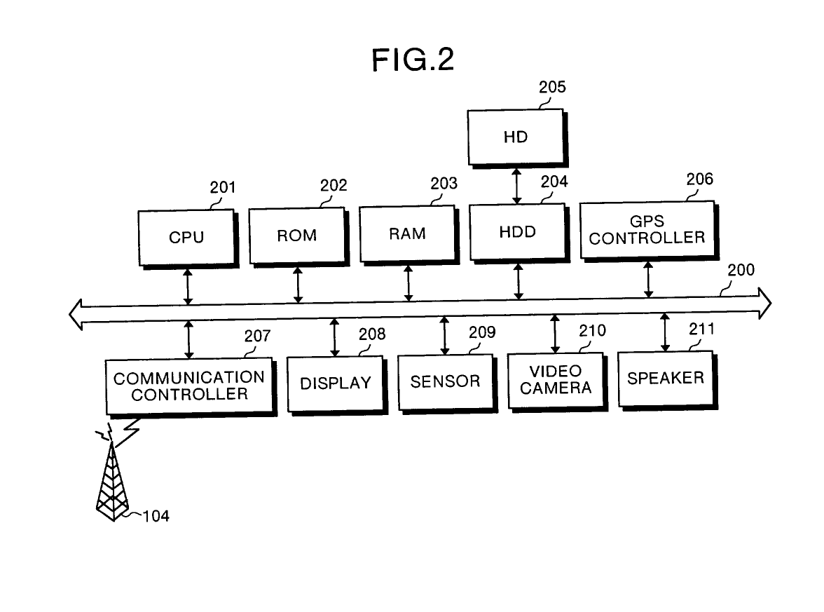

The hardware structure of the vehicle-installed terminal unit 102 as the insurance premium setting apparatus or the insurance premium setting terminal unit according to the embodiment of the present invention will be explained below. FIG. 2 is a block diagram which shows one example of the hardware structure of the vehicle-installed terminal unit 102.

In FIG. 2, the vehicle-installed terminal unit 102 comprises a CPU 201, a ROM 202, a RAM 203, an HDD (hard disk drive) 204, an HD (hard disk) 205, a GPS controller 206, a communication controller 207, a display 208, a sensor 209, a video camera 210, and a speaker 211. These constituent elements are connected to each other via a bus 200.

The CPU 201 carries out a total control of the vehicle-installed terminal unit 102. The ROM 202 stores a program like a boot program. The RAM 203 is used as a work area of the CPU 201. The HDD 204 controls a reading/writing of data from/to the HD 205 based on the control of the CPU 201. The HD 205 stores data written under the control of the HDD 204.

The GPS controller 206 receives waves from the GPS satellites 105 shown in FIG. 1, and obtains a geometric position of the own vehicle from the GPS satellites 105. It is possible to measure a position at any point on the earth. A carrier wave of 1.575.42 MHz that is the L1 wave carrying a C/A (coarse and access) code and a navigation message is used as the wave. The C/A code has a bit rate of 1.023 Mbps, and a code length of 1023 bits=1 ms. The navigation message has a bit rate of 40 bps. The code length of the navigation message is 300 bits=6 s for a sub frame, and 1400 bits=30 s for a main frame. Five sub frames constitute one main frame, and twenty-five main frames constitute one master frame.

The communication controller 207 controls a transmission/reception of a wave to/from the relay station (radio base station) 104. The communication controller 207 is connected to the network 100, and is further connected to the management server 101 via the network 100. The communication controller 207 takes an interface between the network 100 and the inside of the unit 102, and controls an input/output of data to/from the management server 101.

The display 208 displays a cursor, icons, a toolbox, and data such as a document, an image, and functional information. The display 208 is a TFT liquid crystal display, for example, or may be a display of a car navigation system.

The sensor 209 includes vehicle sensors such as a speedometer, a brake and accelerator tread sensor, a steering wheel rotation sensor, and a hard acceleration or hard deceleration sensor. The sensor 209 also includes vehicle internal/external situation sensors like an inter-vehicle distance sensor, a wave status detection sensor that monitors and detects a status of a wave transmission from the relay station 104, and a position sensor that specifies a position of the vehicle. The GPS controller 206 may be substituted for the position sensor.

The video camera 210 is installed on the vehicle 103. The video camera 210 picks up images of an equation of a driver, a status of the outside the vehicle as viewed from the driver, a status of the front side, rear side, left side, and right side of the vehicle 103, and an image reflected from a rearview mirror and a fender mirror. An image picked-up as required is recorded onto the HD 205 or the like with an image picked-up time. The speaker 211 outputs information (for example, voice like warning information) in place of the display 208, or together with the display 208.

[Hardware Structure of the Management Server]

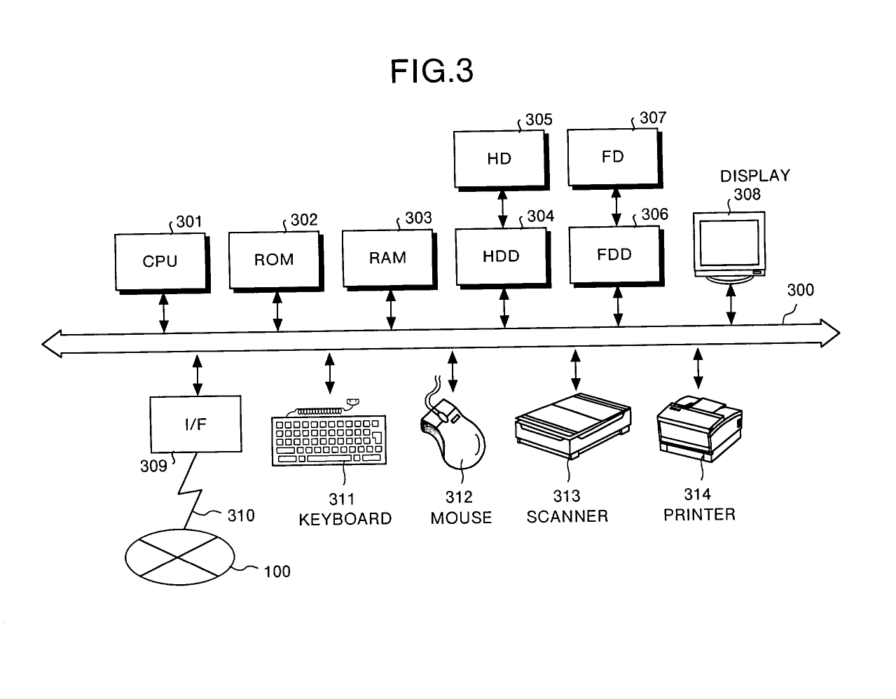

The hardware structure of the management server 101 as the insurance premium setting apparatus according to the embodiment of the present invention will be explained below. FIG. 3 is a block diagram which shows one example of the hardware structure of the insurance premium setting apparatus (the management server 101) according to the embodiment of the present invention.

In FIG. 3, the management server 101 comprises a CPU 301, a ROM 302, a RAM 303, an HDD 304, an HD 305, an FDD (flexible disk drive) 306, an FD (flexible disk) 307 as one example of a detachable recording medium, a display 308, an I/F (interface) 309, a keyboard 311, a mouse 312, a scanner 313, and a printer 314. These constituent elements are connected to each other via a bus 300.

The CPU 301 carries out a total control of the management server 101. The ROM 302 stores a program like a boot program. The RAM 303 is used as a work area of the CPU 301. The HDD 304 controls a reading/writing of data from/to the HDD 305 based on the control of the CPU 301. The HD 305 stores data written under the control of the HDD 304.

The FDD 306 controls a reading/writing of data from/to the FD 307 based on the control of the CPU 301. The FD 307 stores data written under the control of the FDD 306, and allows an information processing unit to read the data stored in the FD 307. As a detachable recording medium, a CD-ROM (CD-R, CD-RW), an MO, a DVD (digital versatile disk), or a memory card may be used, in addition to the FD 307. The display 308 displays a cursor, icons, a tool box, and data such as a document, an image, and functional information. The display 308 is a CRT, a TFT liquid crystal display, or a plasma display.

The I/F (interface) 309 is connected to the network 100 like a LAN or the Internet via a communication line 310, and is further connected to other server or information processing unit via the network 100. The I/F 309 takes an interface between the network 100 and the inside of the server 101, and controls an input/output of data to/from other server or information processing unit. The I/F 309 is a modem or the like.

The keyboard 311 has keys for inputting characters, numbers, and various kinds of instructions, and inputs data. The keyboard 311 may be a touch panel type input pad or a ten-digit key pad. The mouse 312 moves the cursor, selects a range, moves a window, and changes a size of the window. A track ball, a joystick, a cross-key, or a jog dial that has a function of a pointing device may be also be used for the mouse 312.

The scanner 313 optically reads an image like a driver image, and captures image data into the information processing unit. The printer 314 prints image data and document data of an insurance policy. The printer 314 may be a laser printer, an inkjet printer, or the like.

[Functional Structure of the Vehicle-Installed Terminal Unit]

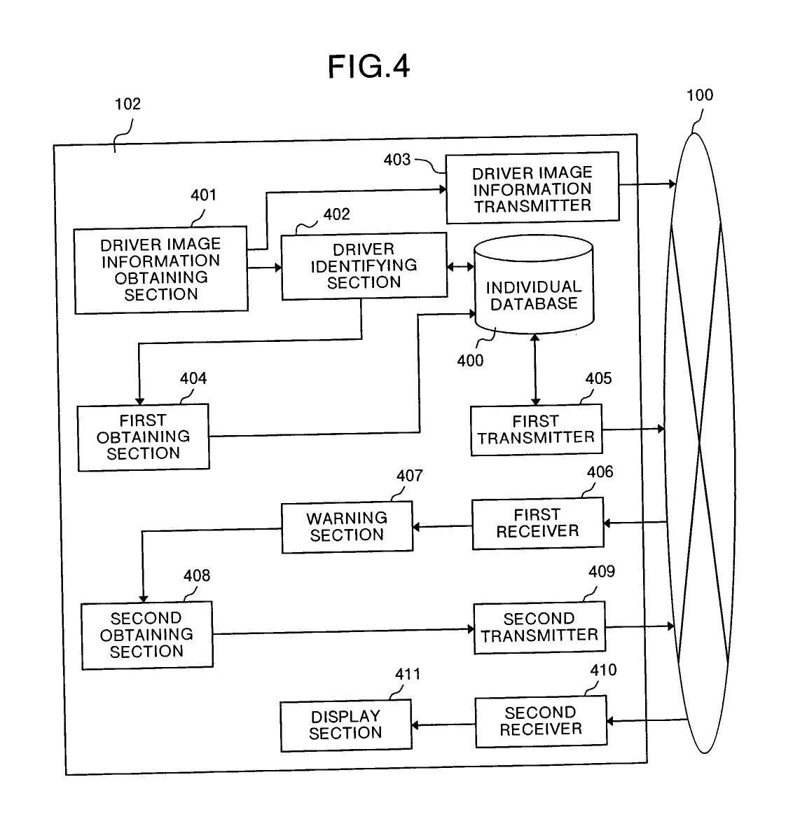

The functional structure of the vehicle-installed terminal unit 102 as the insurance premium setting terminal unit according to the embodiment of the present invention will be explained below. FIG. 4 is a block diagram which shows the functional structure of the vehicle-installed terminal unit 102. In FIG. 4, the vehicle-installed terminal unit 102 includes an individual database 400, a driver image information obtaining section 401, a driver identifying section 402, a driver image information transmitter 403, a first obtaining section 404, a first transmitter 405, a first receiver 406, a warning section 407, a second obtaining section 408, a second transmitter 409, a second receiver 410, and a display section 411.

The individual database 400 is used for the vehicle-installed terminal unit 102, of which details will be explained later. The individual database 400 realizes its function using the ROM 202, the RAM 203, the HD 205, and the HDD 204.

The driver image information obtaining section 401 obtains image information for a driver of the vehicle 103. The driver image information obtaining section 401 obtains image information when the driver has seated on the driving seat of the vehicle 103, or when the key has been inserted into the vehicle, or when the engine has been started. The driver image information obtaining section 401 realizes its function using the video camera 210 shown in FIG. 2, particularly, a video camera for picking up an image of the driver.

The driver identifying section 402 identifies a driver by referring to the individual database 400 based on the image information obtained by the driver image information obtaining section 401. In other words, the driver identifying section 402 compares the image information obtained by the driver image information obtaining section 401 with the image information in the individual database 400. The driver identifying section 402 identifies a driver based on whether characteristics of shapes of the face (eyes, nose, mouth) or ears of these image information coincide with each other or not. The driver identifying section 402 realizes its function by executing programs stored in the ROM 202, the RAM 203, and the HD 205 shown in FIG. 2 with the CPU 201.

The driver image information transmitter 403 transmits the image information obtained by the driver image information obtaining section 401 to the management server 101 via the network 100. The management server 101 can specify the driver based on the image information. Therefore, it is sufficient to have an installment of either one of the driver identifying section 402 and the driver image information transmitter 403. When the driver image information transmitter 403 transmits the image information for the driver, the driver identifying section 402 is not necessary.

The first obtaining section 404 obtains at least either one of the driving information for the driver of the vehicle 103 and the position information for the vehicle 103. The driving information includes at least any one of a physical status of the driver during the driving, an operation status of the vehicle, and a safety confirmation status. Specifically, the driving information includes information from the vehicle sensors such as a speed of the vehicle 103, hard acceleration/hard deceleration, a frequency of braking, abrupt steering, and hard braking, and information from sensors detecting vehicle internal/external situations such as an image showing the outside of the vehicle, an image showing how the driver is driving (for example, an image that identifies a view line), or a signal image, or information relating to an image picked-up by the video camera. Based on these pieces of information, it is possible to confirm a physical status (for example, a status of the driver keeping eyes off the road), or a safety confirmation status (for example, a status of keeping the rule of the signal mechanism). The obtained driving information is stored into the individual database 400.

The position information consists of information of east longitude and north latitude from the vehicle internal/external situation sensors or the GPS controller 206. The position information is stored into a vehicle movement management database 510. The first obtaining section 404 realizes its function by using the sensor 209, the video camera 210, and the GPS controller 206 shown in FIG. 2.

The first transmitter 405 transmits at least either one of the driving information and the position information obtained by the first obtaining section 404, to the management server 101 via the network 100.

The first receiver 406 receives the information relating to driving response and behavior from the management server 101 via the network 100. The information relating to driving response and behavior is related to the driving response and behavior recommendable to the driver that has been estimated by the management server 101 based on at least one of the driving information and the position information transmitted from the first transmitter 405 to the management server 101. Detailed contents of the information relating to the driving response and behavior will be explained later.

The warning section 407 warns the driver based on the information relating to the driving response and behavior received by the first receiver 406. The warning section 407 warns the driver by displaying characters or images on the display screen or outputting voice or alarm sound. Alternatively, when the vehicle 103 has stopped, a required video picture may be reproduced. Further, it is also possible to warn the driver by spraying an aromatic, or by rapidly changing the room temperature or humidity within the chamber. Further, depending on the driving response and behavior, the method of warning the driver may be changed. The warning section 407 realizes its function using the display 208 or the speaker 211 shown in FIG. 2, for example.

The second obtaining section 408 obtains driving information for the driver after the warning section 407 has warned the driver. The driving information obtained and its obtaining method are similar to those of the first obtaining section 404. The second obtaining section 408 realizes its function by using the sensor 209, the video camera 210, and the GPS controller 206 shown in FIG. 2.

The second obtaining section 408 may also have a function of detecting and deciding characteristics relating to the driver's operation other than the operation during the normal driving period, such that how quickly the driver reacts after the warning has been given to the driver or how strictly the driver follows a risk avoidance instruction. In this case, the second obtaining section 408 realizes its function by executing programs stored in the ROM 202, the RAM 203, and the HD 205 shown in FIG. 2 with the CPU 201.

The second transmitter 409 transmits the driving information obtained by the second obtaining section 408 to the management server 101 via the network 100. The second receiver 410 receives the information relating to the premium of the driver set by the management server 101 based on the driving information transmitted by the second transmitter 409.

The display section 411 displays the information relating to the premium of the driver received by the second receiver 410. The display section 411 realizes its function using the display 208 shown in FIG. 2, for example.

The transmitters 403, 405, and 409 and the receivers 406 and 410 realize their functions respectively using the communication controller 207 as shown in FIG. 2, for example. More specifically, these sections realize their functions respectively by executing programs stored in the ROM 202, the RAM 203, and the HD 205 shown in FIG. 2 with the CPU 201.

[Functional Structure of the Management Server]

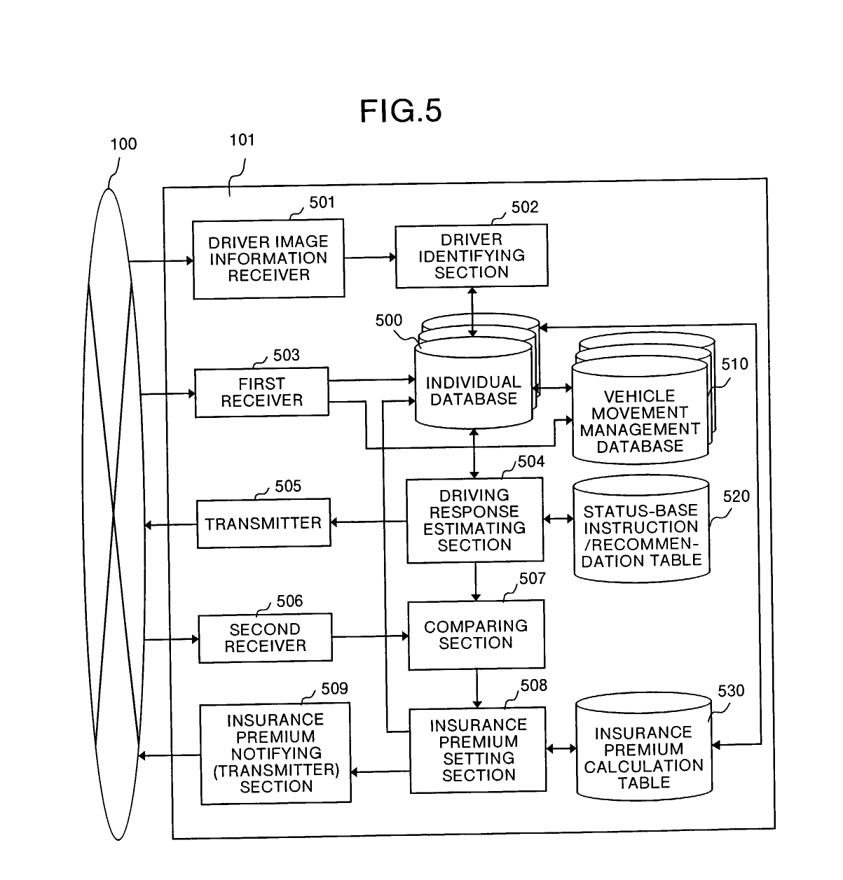

The functional structure of the management server 101 as the insurance premium setting apparatus according to the embodiment of the present invention will be explained below. FIG. 5 is a block diagram which shows the functional structure of the management server 101.

In FIG. 5, the management server 101 includes a driver image information receiver 501, a driver identifying section 502, a first receiver 503, a driving response estimating section 504, a transmitter 505, a second receiver 506, a comparing section 507, an insurance premium setting section 508, and an insurance premium notifying (transmitting) section 509. Further, the management server 101 comprises an individual database 500 for the management server 101, a vehicle movement management database 510, an status-base instruction/recommendation table 520, and an insurance premium calculation table 530. Alternatively, the management server 101 can be connected to these databases and tables via the network 100.

The driver image information receiver 501 receives obtained image information for a driver of the vehicle 103, from the vehicle 103. The driver identifying section 502 identifies the driver by referring to the individual database 500 based on the image information received by the driver image information receiver 501. The details of the contents are similar to those of the driver identifying section 402, and therefore, their explanation will be omitted.

The first receiver 503 receives at least either one of the driving information for the driver of the vehicle 103 and the position information for the vehicle 103, from the vehicle 103.

The driving response estimating section 504 estimates any one or both of driving response and behavior recommendable to the driver based on at least either one of the driving information and the position information received by the first receiver 503. Further, the driving response estimating section 504 may estimate driving response and behavior recommendable to the driver based on at least either one of the driving information and the position information, and the information relating to the vehicle 103, that is, a vehicle driving record of “driver driving record semi-fixed information” 605 and “other vehicle utilization status information” 703 in the individual database 500.

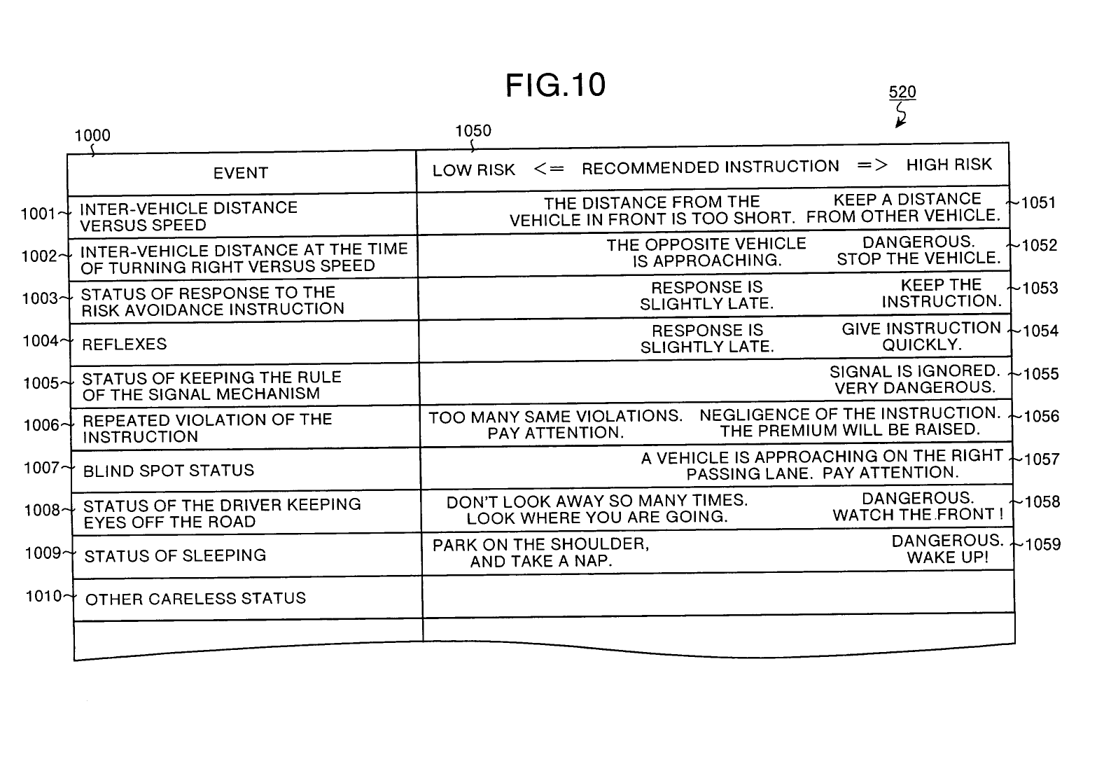

Specifically, based on the above information, the driving response estimating section 504 estimates recommendable driving response and behavior by determining a recommended instruction for each event (for example, “inter-vehicle distance versus speed”) using the status-base instruction/recommendation table 520 shown in FIG. 10 to be described later.

The transmitter 505 transmits the information relating to any one and both of the driving response and behavior estimated by the driving response estimating section 504, to the vehicle 103. The second receiver 506 receives from the vehicle 103 the driving information for the driver after the information relating to the driving response and behavior has been transmitted from the transmitter 505 to the vehicle 103.

The comparing section 507 compares the driving information that has been received by the second receiver with the information relating to the driving response and behavior that has been estimated by the driving response estimating section 504 and stored in the individual database 500. Specifically, the comparing section 507 compares both information by detecting and deciding characteristics relating to the driver's operation other than the operation during the normal operation period, such that how quickly the driver reacts after the warning has been given to the driver or how strictly the driver follows a risk avoidance instruction.

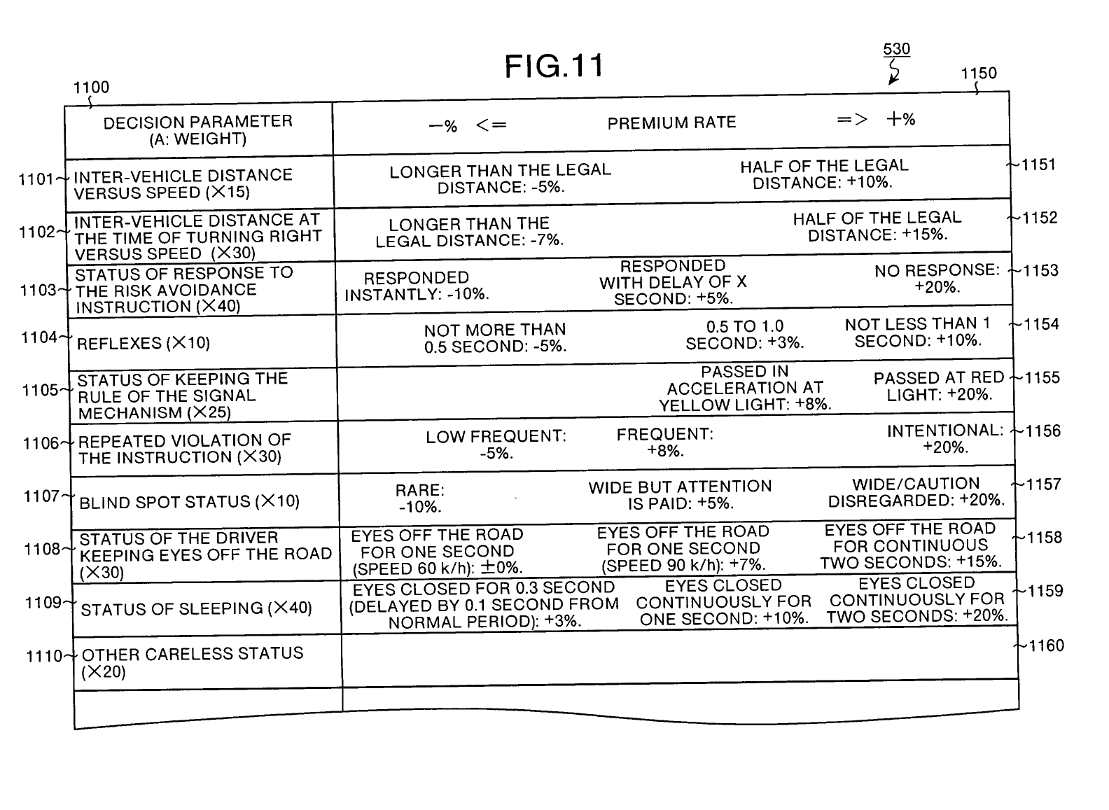

The insurance premium setting section 508 sets a premium to the driver based on a result of the comparison carried out by the comparing section 507. Specifically, the insurance premium setting section 508 calculates and sets the premium by using the insurance premium calculation table 530 shown in FIG. 11 to be described later and a calculation equation (equation (3) to be described later). Detailed contents of the calculation and setting of the premium will be explained later.

The insurance premium notifying (transmitting) section 509 transmits the information relating to the premium set by the insurance premium setting section 508 to the vehicle-installed terminal unit 102 via the network 100.

The driver identifying section 502, the driving response estimating section 504, the comparing section 507, and the insurance premium setting section 508 realize their functions respectively by executing programs stored in the ROM 302, the RAM 303, the HD 305, or the FD 307 shown in FIG. 3 with the CPU 301.

The receivers 501, 503, and 506 and the transmitters 505 and 509 realize their functions respectively with the I/F 309 shown in FIG. 3. Specifically, these sections realize their functions respectively by executing programs stored in the ROM 302, the RAM 303, the HD 305, or the FD 307 shown in FIG. 3 with the CPU 301.

Detailed contents of the individual database 500, the vehicle movement management database 510, the status-base instruction/recommendation table 520, and the insurance premium calculation table 530 will be explained later. The individual database 500, the vehicle movement management database 510, the status-base instruction/recommendation table 520, and the insurance premium calculation table 530 realize their functions respectively by using the ROM 302, the RAM 303, the HD 305, the HDD 304, the FD 307, and the FDD 306 shown in FIG. 3.

[Contents of the Individual Databases 400 and 500]

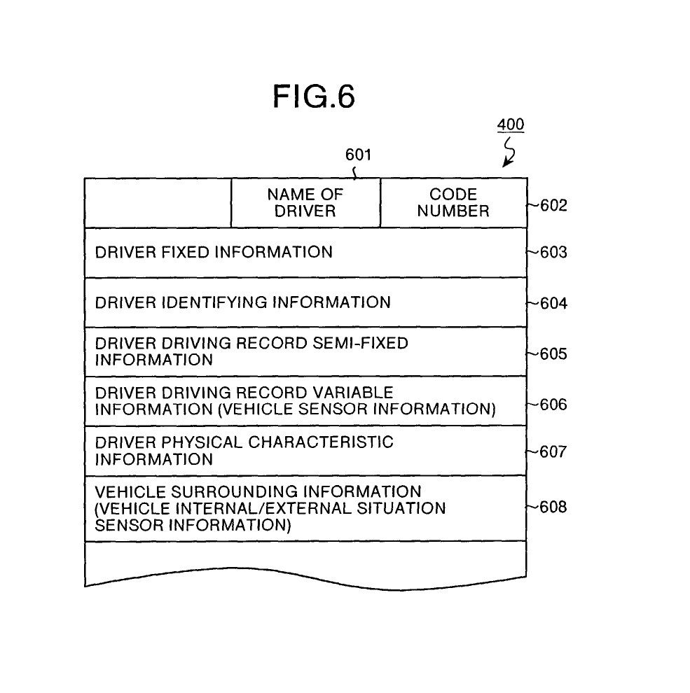

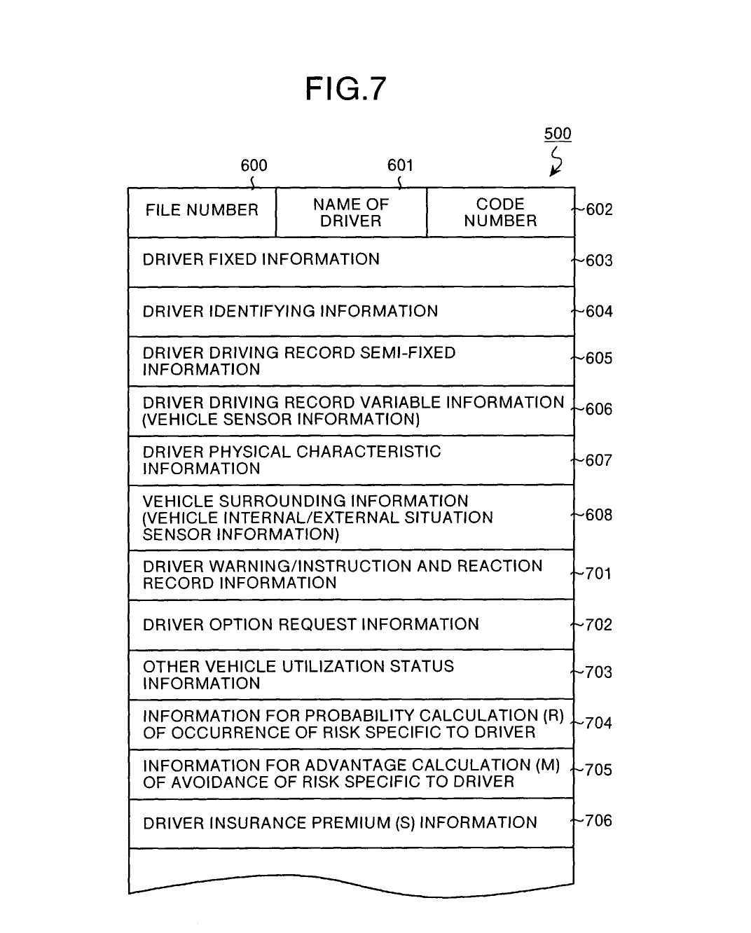

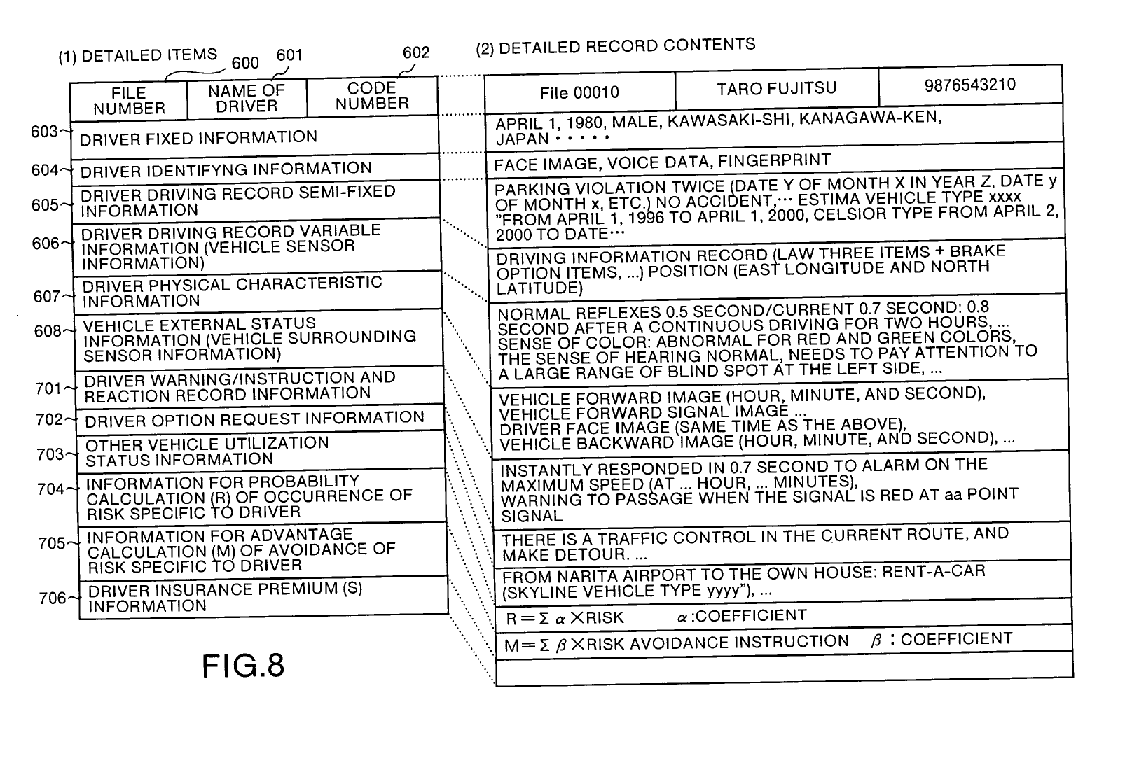

The contents of the individual database 400 for the vehicle-installed terminal unit and the individual database 500 for the management server will be explained below. FIG. 6 is an explanatory diagram which shows the contents of the individual database 400 that is held by the vehicle-installed terminal unit 102 as the insurance premium setting terminal unit according to the embodiment of the present invention. FIG. 7 is an explanatory diagram which shows the contents of the individual database 500 that is held by the management server 101 as the insurance premium setting apparatus according to the embodiment of the present invention. FIG. 8 is an explanatory diagram which shows the detailed contents of the individual databases 400 and 500.

In FIG. 6, the individual database 400 consists of “name of driver” 601, “code number” 602, “driver fixed information” 603, “driver identifying information” 604, “driver driving record semi-fixed information” 605, “driver driving record variable information” 606, “driver physical characteristic information” 607, and “vehicle surrounding information” 608.

As shown in FIG. 7, the individual database 500 for the management server consists of the above information 601 to 608, and “file number” 600 specific to the driver, “driver warning/instruction and reaction record information” 701, “driver option request information” 702, “other vehicle utilization status information” 703, “information for probability calculation (R) of occurrence of risk specific to driver” 704, “information for advantage calculation (M) of avoidance of risk specific to driver” 705, and “driver insurance premium (S) information” 706.

As shown in FIG. 8, the “file number” 600 stores a serial number that is specific to the driver. The “name of driver” 601 stores the name of the driver. The “code number” 602 stores the code number of the driver. The “driver fixed information” 603 stores the information for the birthday, gender, nationality, and family registered address of the driver respectively.

The “driver identifying information” 604 stores the driver face image information, voice data, and a fingerprint image of the driver that identify the driver. The “driver driving record semi-fixed information” 605 stores the information relating to traffic violation/accident record (for example, “parking violation twice (date Y of month X in year Z, date y of month x, etc.), no accident, . . . ”), and vehicle/driving record (for example, “ESTIMA, vehicle type xxxx, from Apr. 1, 1996 to Apr. 1, 2000, and CELSIOR, . . . , from Apr. 2, 2000 to . . . ”). The information relating to a vehicle includes displacement and horsepower of the vehicle, and information relating to safe driving supporting units like ABS, or an airbag.

The “driver driving record variable information” 606 stores the information of a speed, hard acceleration/hard deceleration, a frequency of braking, and abrupt steering, and position information (east longitude and north latitude) of the vehicle obtained from the first obtaining section 404 (vehicle sensor). The “driver physical characteristic information” 607 stores the driver reflexes (for example, “normal reflexes 0.5 second/current 0.7 second: 0.8 second after a continuous driving for two hours”), and information relating to the sense of color and the sense of hearing (for example, “the sense of color: abnormal for red and green colors, and the sense of hearing normal, needs to pay attention to a large range of blind spot at the left side, . . . ).

The “vehicle surrounding information” 608 stores the vehicle forward image information, the vehicle forward signal image information, the driver face image information, the vehicle backward image information, and information on the distance between vehicles in each image with time (hour, second, and minute) according to the needs, obtained from the first obtaining section 404 (vehicle internal/external situation sensors).

The “driver warning/instruction and reaction record information” 701 stores the information relating to the record of warning/instruction to the driver and the record of reaction to the warning/instruction (for example, instantly responded in 0.7 second to “alarm on the maximum speed (at . . . hour, . . . minutes), warning to passage when the signal is red at aa point signal”), linked with the insurance premium calculation table 530 to be described later.

The “driver option request information” 702 stores weather information, and information relating to the route guidance (for example, “there is a traffic control in the current route, and make detour.”). The “other vehicle utilization status information” 703 stores the information relating to a utilization status of a vehicle (for example, a-rent-a-car) that is different from a vehicle in ordinary use (from Narita Airport to the own house: rent-a-car (Skyline, vehicle type yyyy”), linked with the vehicle movement management database 510.

The “information for probability calculation (R) of occurrence of risk specific to driver” 704 stores occurrence probability (R) of risk specific to a driver calculated according to the following equation (1).

R=Σα×risk (1)

where α is a coefficient.

The “information for advantage calculation (M) of avoidance of risk specific to driver” 705 stores avoidance advantage (M) of risk specific to a driver calculated according to the following equation (2).

R=Σβ×risk avoidance instruction (2)

where β is a coefficient.

The “driver insurance premium (S) information” 706 stores a driver insurance premium (S) calculated according to the following equation (3). The calculation of the insurance premium will be explained in detail later.

Insurance premium S=ΣA×unit time×premium rate×vehicle own rate data× . . . (3)

where A represents a weight.

[Contents of the Vehicle Movement Management Database]

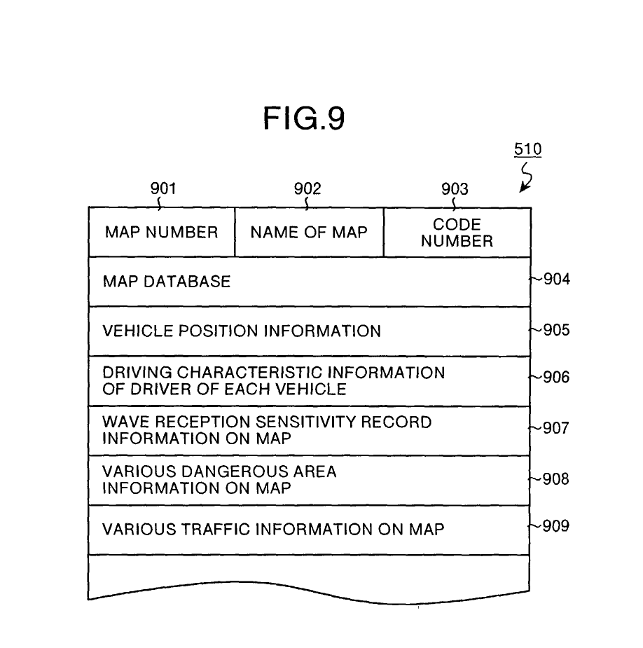

The contents of the vehicle movement management database 510 will be explained below. FIG. 9 is an explanatory diagram which shows the contents of the vehicle movement management database 510 held by the management server 101 as the insurance premium setting apparatus according to the embodiment of the present invention. In FIG. 9, the vehicle movement management database 510 includes “map number” 901, “name of map” 902, “code number” 903, “map database” 904, “vehicle position information” 905, “driving characteristic information of driver of each vehicle” 906, “wave reception sensitivity record information on map” 907, “various dangerous area information on map” 908, and “various traffic information on map” 909.

The “vehicle position information” 905 stores the information relating to a position (east longitude and north latitude) of each vehicle 103. The “driving characteristic information of driver of each vehicle” 906 stores the “file number” 600 of the driver individual database 500, and can be linked with the individual database 500 based on this file number 600. The “wave reception sensitivity record information on map” 907 stores the information relating to the record of a status of the wave sensitivity of communications with the vehicle 103. It is possible to decide whether it has been impossible to give sufficient warning to the vehicle as the vehicle-installed terminal unit 102 has not been able to receive the information relating to the warning due to low wave sensitivity. It is possible to use this information as a reference for calculating the premium.

The “various dangerous area information on map” 908 stores the area (region) information relating to bridges that have weight limit or areas where many accidents occur. The “various traffic information on map” 909 stores traffic congestion information, traffic control information, and accident information.

[Contents of the Status-Base Instruction/Recommendation Table]

The contents of the status-base instruction/recommendation table 520 will be explained below. FIG. 10 is an explanatory diagram which shows the contents of the status-base instruction/recommendation table 520 held by the management server 101 as the insurance premium setting apparatus according to the embodiment of the present invention. In FIG. 10, the status-base instruction/recommendation table 520 shows a relationship between “event” 1000 and “recommended instruction” 1050 corresponding to the risk of the event.

In the “recommended instruction” column 1050 of the status-base instruction/recommendation table 520, instruction items having the lowest risks are described at the left side, and instruction items having the highest risks are described at the right side. For example, when the “event” 1000 is “inter-vehicle distance versus speed” 1001, “The distance from the vehicle in front is too short.” is described in the middle of a column 1051 of the column “recommended instruction”. Therefore, it can be understood that this risk is about the intermediate. The instruction “Keep a distance from other vehicle” is described at the right side. Therefore, it can be understood that this risk is high.

Similarly, when the event is “inter-vehicle distance at the time of turning right versus speed” 1002, a recommended instruction 1052 becomes “The opposite vehicle is approaching”. When the risk is high, the instruction becomes “Dangerous. Stop the vehicle”. Similarly, when the event is “status of response to the risk avoidance instruction” 1003, a recommended instruction 1053 is “Response is slightly late.” When the risk is high, the instruction becomes “Keep the instruction”. Similarly, when the event is “reflexes” 1004, a recommended instruction 1054 “Response is slightly late”. When the risk is high, the instruction becomes “Give instruction quickly”.

When the event is “status of keeping the rule of the signal mechanism” 1005, a negligence of the signal is regarded as a situation with a high risk at any time. In this case, a recommended instruction 1055 becomes only “Signal is ignored. Very dangerous”. When the event is “repeated violation of the instruction” 1006, a recommended instruction 1056 becomes “Too many violations. Pay attention”. When the risk becomes high due to the repeated violations, “Negligence of the instruction. The premium will be raised”. Similar instructions are given to the rest of events “blind spot status” 1007, “status of the driver keeping eyes off the road” 1008, “status of sleeping” 1009, and “other careless status” 1010.

[Contents of the Insurance Premium Calculation Table]

The contents of the insurance premium calculation table 530 will be explained below. FIG. 11 is an explanatory diagram which shows the contents of the insurance premium calculation table 530 held by the management server 101 as the insurance premium setting apparatus according to the embodiment of the present invention. In FIG. 11, the insurance premium calculation table 530 shows a relationship between “decision parameter” 1100 and “premium rate” 1150 corresponding to the level of the risk of the parameter.

Each decision parameter is provided with a weight A shown in the equation (3). For example, “inter-vehicle distance versus speed” 1101 as the decision parameter has a weight “×15”. “Status of response to the risk avoidance instruction” 1103 as the decision parameter has a weight “×40”. Therefore, it can be understood that the “status of response to the risk avoidance instruction” 1103 has a larger weight than that of the “inter-vehicle distance versus speed” 1101. As explained above, the equation (3) is provided as a calculation equation that reflects items that take into account driver's own characteristics such as driver's reflexes and repeated violence of instructions and weights of these items, as well as the normal fixed legal speed versus relative distance.

In the “premium rate” column 1150 of the insurance premium calculation table 530, premium rates having the lowest risks are described at the left side, and premium rates having the highest risks are described at the right side. Specifically, the decision parameter “inter-vehicle distance versus speed” 1101 has a low risk when the distance is “longer than the legal distance”, and the premium rate in this case is “−5%”. On the other hand, when the distance is “half of the legal distance”, the risk becomes high, and the premium rate in this case becomes “+10%”.

[Contents of the Processing in the Vehicle-Installed Terminal Unit 102]

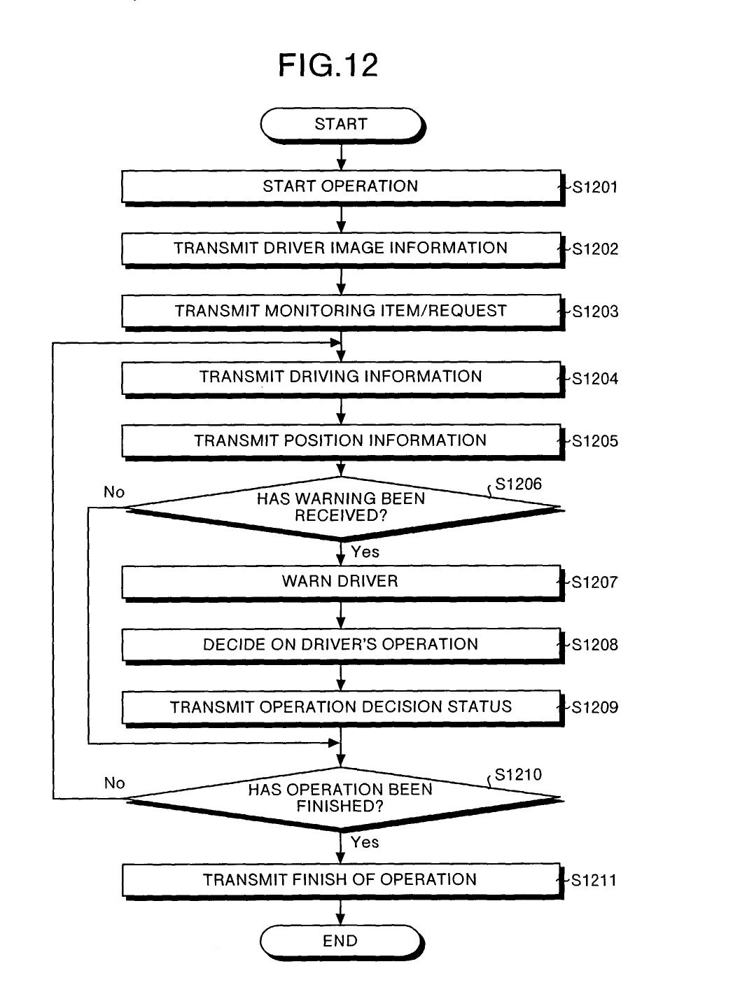

The contents of the processing in the vehicle-installed terminal unit 102 as the insurance premium setting terminal unit will be explained below. FIG. 12 is a flowchart which shows steps of the processing in the vehicle-installed terminal unit 102 as the insurance premium setting terminal unit according to the embodiment of the present invention.

In the flowchart shown in FIG. 12, the vehicle-installed terminal unit 102 transmits operation starting information to the management server 101 (step S1201). Based on this, the management server 101 starts monitoring the vehicle. The sensor 209 may automatically transmit the operation starting information when detecting that the key has been inserted into the vehicle, the engine has been started, or that the driver has seated on the driving seat. Alternatively, the driver may operate to show the operation starting by using the vehicle-installed terminal unit 102.

In simultaneous with the starting of the operation, in order to match the driver individual databases 400 and 500, the vehicle-installed terminal unit 102 transmits the driver image information to the management server 101 (step S1202) Further, in simultaneous with the starting of the operation, the vehicle-installed terminal unit 102 transmits items of which monitoring are to be requested and special request items such as a request for guidance of safe routes, if any, to the management server 101 (step S1203) The vehicle-installed terminal unit 102 transmits driving information (no information at the beginning) and position information obtained by the first obtaining section 404, to the management server 101 (steps S1204 and S1205). Then, the vehicle-installed terminal unit 102 decides whether information relating to warning has been received from the management server 101 or not (step S1206). When information relating to warning has not been received (No at step S1206), the process proceeds to step S1210. On the other hand, when information relating to warning has been received (Yes at step S1206), the vehicle-installed terminal unit 102 transmits the warning to the driver by using voice, alarm sound, or image display (step S1207).

The vehicle-installed terminal unit 102 detects and decides on characteristics relating to the driver's operation other than the operation during the normal driving period, such that how quickly the driver reacts or how strictly the driver follows a risk avoidance instruction (step S1208). The vehicle-installed terminal unit 102 transmits the operation decision status to the management server 101 (step S1209). The vehicle-installed terminal unit 102 may transmit to the management server 101 only the driving information and the position information after transmission of the warning, and the management server 101 may detect and decide on the above characteristics at step S1208.

The vehicle-installed terminal unit 102 decides whether the operation has been finished or not (step S1210) When the operation has not been finished (No at step S1210) the process returns to step S1204, and the processing at steps S1204 to S1210 is repeated. When the operation has been finished (Yes at step S1210), the vehicle-installed terminal unit 102 transmits the information on the finish of the operation to the management server 101 (step S1211). The sensor 209 may automatically transmit the information on the finish of the operation when detecting that the engine has stopped, the key has been taken out from the vehicle 103, or that the driver has left the driving seat. Alternatively, the driver may operate the vehicle-installed terminal unit 102 to show the finish of the driving.

[Contents of the Processing in the Management Server 101]

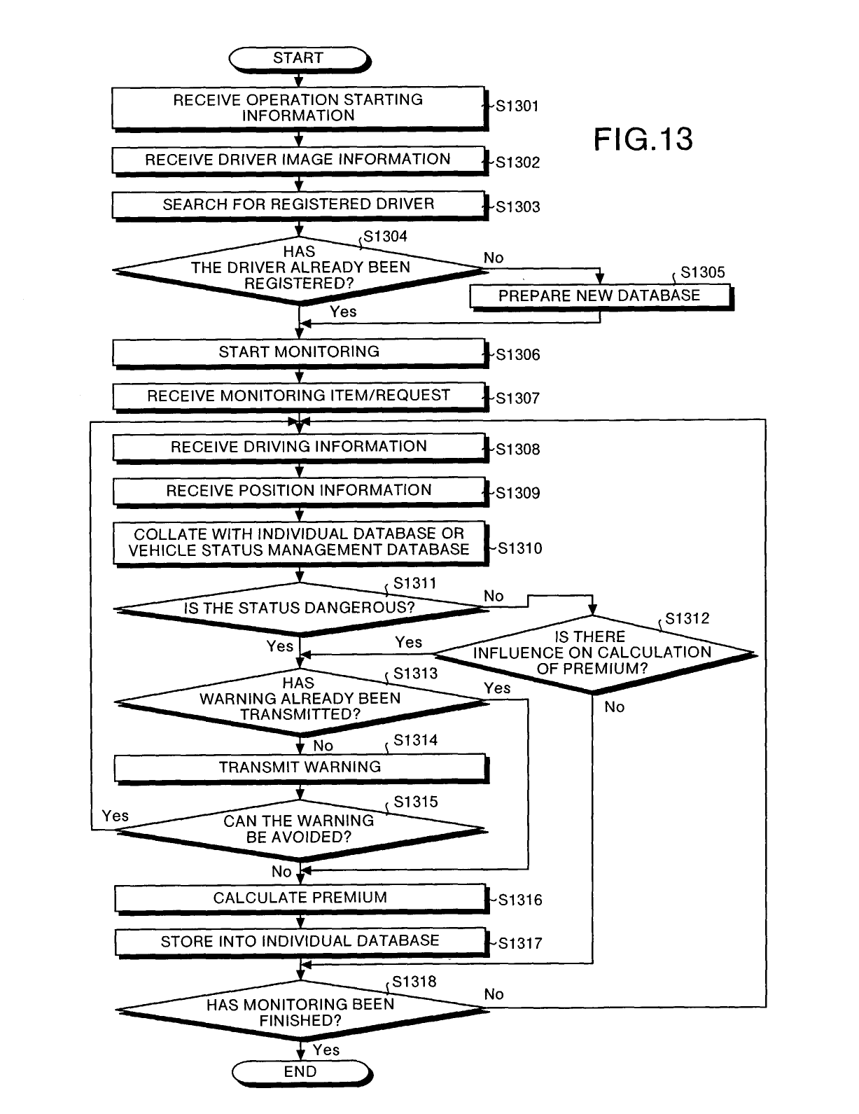

The contents of the processing in the management server 101 as the insurance premium setting apparatus will be explained below. FIG. 13 is a flowchart which shows steps of the processing in the management server 101 as the insurance premium setting apparatus according to the embodiment of the present invention.

In the flowchart shown in FIG. 13, the management server 101 receives driving starting information and driver image information transmitted from the vehicle-installed terminal unit 102 (steps S1301 and S1302). The management server 101 checks whether or not the driver has been registered as a driver to be monitored based on the data such as the driver image (step S1303). The management server 101 decides whether the driver has been registered or not (step S1304). When the driver has not been registered (No at step S1304), the management server 101 prepares a new driver individual database 500 (step S1305). When the driver has been registered (Yes at step S1304), the monitoring is continued (step S1306).

The management server 101 receives from the vehicle-installed terminal unit 102 items of which monitoring are to be requested and special request items such as a request for guidance of safe routes (step S1307). Then, the management server 101 receives driving information and position information (steps S1308 and S1309), and collates these pieces of information with the individual database or the vehicle movement management database (step S1310).

The management server 101 estimates whether a dangerous status is coming up or not (step S1311). When a dangerous status is not coming up (No at step S1311), the management server 101 decides whether the calculation of the premium is affected by the estimation or not (step S1312). When the calculation of the premium is affected by the estimation (Yes at step S1312), the process proceeds to step S1313. On the other hand, when the calculation of the premium is not affected (No at step S1312), the process proceeds to step S1318.

At step S1311, when the vehicle is in a dangerous status (Yes at step S1311), the management server 101 determines the next contents of warning to be transmitted by referring to the status-base instruction/recommendation table 520. Then, the management server 101 decides whether the warning whose contents are the same as those of the warning to be transmitted has already been transmitted to the vehicle-installed terminal unit 102 of the vehicle 130 or not (step S1313).

At step S1313, when second or further warning is to be given this time (Yes at step S1313), the process proceeds to step S1316, and this fact is taken into account in calculating the premium. On the other hand, when the warning is to be given for the first time this time, that is, when the same warning has not yet been given in the past (No at step S1313), the management server 101 transmits the warning (step S1314). The management server 101 decides whether the transmitted warning can be avoided from increasing a premium or not (step S1315). The warning that cannot be avoided includes, for example, a serious violence of the traffic rule, such as “negligence of signal” that has a high level of risk. Therefore, when the transmitted warning cannot be avoided (No at step S1315), the process proceeds to step S1316 even though the warning is the first time, and this fact is taken into account in calculating the premium.

At step S1315, when the transmitted warning can be avoided (Yes at step S1315), the process returns to step S1308, and the management server 101 waits for the reception of the next driving information and position information. When the decision at step S1313 is Yes or when the decision at step S1315 is No, the management server 101 calculates the premium by using the insurance premium calculation table 530 (step S1316), and stores the calculated information into the individual database 500 (step S1317).

Thereafter, the management server 101 decides whether the monitoring has been finished or not (step S1318). When the monitoring has not been finished (No at step S1318), the process proceeds to step S1308, and the processing at steps S1308 to S1318 is repeated. When the monitoring has been finished (Yes at step S1318), the series of processing is finished.

As explained above, according to the present embodiment, it is monitored how the driver is driving. When a driving status that suggests a possibility of an accident that may occur, a driver is warned in the first place. When the driver responses or behaves appropriately to the warning, the premium is not increased or even decreased. On the other hand, when the driver does not response or behave appropriately to the warning, or when the driver does not take any action against the warning, the premium is increased.

Based on this, it is possible to prevent the occurrence of an accident in advance. Therefore, it becomes possible to decrease the number of occurrence of accidents, and it becomes possible to decrease the amount of premiums paid by insured persons and the amount of insurance money paid by the insurance companies. Further, it is allowed to notify the driver in advance that some unconscious driving response and behavior by the driver becomes a factor of increasing the premium. Thus, it becomes possible to improve the driver's driving technique and set an optimum premium for the driver.

When the vehicle 103 is not linked with the management server 101, the vehicle 103 may be provided with the same functions as the driving response estimating section 504, the comparing section 507, and the insurance premium setting section 508, and also with the various databases 500 and 510 and various tables 520 and 530 as shown in FIG. 5. Based on such arrangement, it is also possible to complete a series of processing flow from making decision on risk to giving warning in the vehicle 103.

Although the automobile insurance has been explained in the present embodiment, the application of the invention is not limited to this. It is also possible to apply the invention to damage insurance such as travel accident insurance. In this case, a traveler has a portable information processing terminal unit such as a portable telephone (including a PDA) 106 as the insurance premium setting terminal unit. This portable information processing terminal unit decides whether the driver is taking a dangerous behavior or not, or is in a dangerous area based on the behavior information and the current position of the owner (traveler), and transmits warning information to this effect. When the driver has disregarded this warning information, a high premium rate may be set. In any case, warning is given to the insured person, and the premium may be set based on the behavior of the insured person against this warning.

The insurance premium setting method of the present embodiment may be a computer-readable program prepared in advance. The insurance premium setting method is realized by executing this program on a computer such as a personal computer or a workstation. This program is stored on a computer-readable recording medium such as an HD, an FD, a CD-ROM, an MO, or a DVD, and is executed by the computer by being read from the recording medium. This program may be a transmission medium that can be distributed via a network like the Internet.

As explained above, according to the present invention, it is advantageously possible to obtain the insurance premium setting method, the insurance premium setting program, the insurance premium setting apparatus, and the insurance premium setting terminal unit which can decrease the number of occurrence of accidents, can thereby decrease the amount of premiums paid by insured persons and the amount of insurance money paid by the insurance companies, and can set optimum premiums for the insured persons.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. An insurance premium setting method comprising:
a first obtaining step of obtaining at least either one of driving information for a driver of a vehicle, and position information that shows a position of the vehicle;
a driving response estimating step of estimating any one or both of driving response and behavior recommendable to the driver based on at least either one of the driving information and the position information obtained at the first obtaining step;
a warning step of warning the driver based on the information relating to the driving response and behavior estimated at the driving response estimating step;
a second obtaining step of obtaining driving information for the driver after the driver has been warned at the warning step;
a comparing step of comparing the driving information obtained at the second obtaining step with the information relating to the driving response and behavior estimated at the driving response estimating step; and
an insurance premium setting step of setting a premium of the driver based on a result of the comparison at the comparing step.

2. The insurance premium setting method according to claim 1, further comprising an insurance premium notifying step of notifying the vehicle of the premium for the driver set at the insurance premium setting step.

3. The insurance premium setting method according to claim 1, further comprising:
a driver image information obtaining step of obtaining image information for the driver of the vehicle; and
a driver identifying step of identifying the driver based on the image information obtained at the driver image information obtaining step.

4. The insurance premium setting method according to claim 1, wherein the driving response estimating step includes:
estimating any one or both of driving response and behavior recommendable to the driver based on at least either one of the driving information and the position information, and the information relating to the vehicle.

5. The insurance premium setting method according to claim 1, wherein the driving information includes at least any one of a physical status of the driver during the driving, an operation status of the vehicle, and a safety confirmation status.

6. The insurance premium setting method according to claim 1, wherein the driving information is information relating to an image picked-up by a video camera installed at a predetermined position of the vehicle.

7. An insurance premium setting method comprising:
a first receiving step of receiving from a vehicle at least either one of driving information for a driver of the vehicle, and position information that shows a position of the vehicle;
a driving response estimating step of estimating any one or both of driving response and behavior recommendable to the driver based on at least either one of the driving information and the position information received at the first receiving step;
a transmitting step of transmitting to the vehicle the information relating to the driving response and behavior estimated at the driving response estimating step;
a second receiving step of receiving driving information for the driver after the information relating to the driving response and behavior has been transmitted to the vehicle at the transmitting step;
a comparing step of comparing the driving information received at the second receiving step with the information relating to the driving response and behavior estimated at the driving response estimating step; and
an insurance premium setting step of setting a premium to the driver based on a result of the comparison at the comparing step.

8. The insurance premium setting method according to claim 7, further comprising:
a driver image information receiving step of receiving obtained image information for the driver of the vehicle from the vehicle; and
a driver identifying step of identifying the driver based on the image information received at the driver image information receiving step.

9. The insurance premium setting method according to claim 7, wherein the driving response estimating step includes:
estimating any one or both of driving response and behavior recommendable to the driver based on at least either one of the driving information and the position information, and the information relating to the vehicle.

10. The insurance premium setting method according to claim 7, wherein the driving information includes at least any one of a physical status of the driver during the driving, an operation status of the vehicle, and a safety confirmation status.

11. The insurance premium setting method according to claim 7, wherein the driving information is information relating to an image picked-up by a video camera installed at a predetermined position of the vehicle.

12. An insurance premium setting method comprising:
a first obtaining step of obtaining at least either one of behavior information for an insured person, and position information that shows a position of the insured person;
a behavior estimating step of estimating a behavior recommendable to the insured person based on at least either one of the behavior information and the position information obtained at the first obtaining step;
a warning step of warning the insured person based on the information relating to the behavior estimated at the behavior estimating step;
a second obtaining step of obtaining behavior information for the insured person after the insured person has been warned at the warning step;
a comparing step of comparing the behavior information obtained at the second obtaining step with the information relating to the behavior estimated at the behavior estimating step; and
an insurance premium setting step of setting a premium to the insured person based on a result of the comparison at the comparing step.

13. An insurance premium setting method comprising:
a first receiving step of receiving from an insured person at least either one of behavior information for the insured person, and position information that shows a position of the insured person;
a behavior estimating step of estimating a behavior recommendable to the insured person based on at least either one of the behavior information and the position information received at the first receiving step;
a transmitting step of transmitting the information relating to the behavior estimated at the behavior estimating step, to the insured person;
a second receiving step of receiving from the insured person the behavior information for the insured person after the information relating to the behavior has been transmitted to the insured person at the transmitting step;
a comparing step of comparing the behavior information received at the second receiving step with the information relating to the behavior estimated at the behavior estimating step; and
an insurance premium setting step of setting a premium to the insured person based on a result of the comparison at the comparing step.

14. An insurance premium setting program executed on a computer, the program comprising:
a first obtaining step of obtaining at least either one of driving information for a driver of a vehicle, and position information that shows a position of the vehicle;
a driving response estimating step of estimating any one or both of driving response and behavior recommendable to the driver based on at least either one of the driving information and the position information obtained at the first obtaining step;
a warning step of warning the driver based on the information relating to the driving response and behavior estimated at the driving response estimating step;
a second obtaining step of obtaining driving information for the driver after the driver has been warned at the warning step;
a comparing step of comparing the driving information obtained at the second obtaining step with the information relating to the driving response and behavior estimated at the driving response estimating step; and
an insurance premium setting step of setting a premium to the driver based on a result of the comparison at the comparing step.

15. An insurance premium setting program executed on a computer, the program comprises:
a first receiving step of receiving from a vehicle at least either one of driving information for a driver of the vehicle, and position information that shows a position of the vehicle;
a driving response estimating step of estimating any one or both of driving response and behavior recommendable to the driver based on at least either one of the driving information and the position information received at the first receiving step;
a transmitting step of transmitting to the vehicle the information relating to the driving response and behavior estimated at the driving response estimating step;
a second receiving step of receiving driving information for the driver after the information relating to the driving response and behavior has been transmitted to the vehicle at the transmitting step;
a comparing step of comparing the driving information received at the second receiving step with the information relating to the driving response and behavior estimated at the driving response estimating step; and
an insurance premium setting step of setting a premium to the driver based on a result of the comparison at the comparing step.

16. An insurance premium setting apparatus comprising:
a first obtaining unit which obtains at least either one of driving information for a driver of a vehicle, and position information that shows a position of the vehicle;
a driving response estimating unit which estimates any one or both of driving response and behavior recommendable to the driver based on at least either one of the driving information and the position information obtained by the first obtaining unit;
a warning unit which warns the driver based on the information relating to the driving response and behavior estimated by the driving response estimating unit;
a second obtaining unit which obtains driving information for the driver after the driver has been warned by the warning unit;
a comparing unit which compares the driving information obtained by the second obtaining unit with the information relating to the driving response and behavior estimated by the driving response estimating unit; and
an insurance premium setting unit which sets a premium to the driver based on a result of the comparison by the comparing unit.

17. An insurance premium setting apparatus comprising:
a first receiving unit which receives from a vehicle at least either one of driving information for a driver of the vehicle, and position information that shows a position of the vehicle;
a driving response estimating unit which estimates any one or both of driving response and behavior recommendable to the driver based on at least either one of the driving information and the position information received by the first receiving unit;
a transmitting unit which transmits the information relating to the driving response and behavior estimated by the driving response estimating unit, to the vehicle;
a second receiving unit which receives driving information for the driver after the information relating to the driving response and behavior has been transmitted to the vehicle by the transmitting unit;
a comparing unit which compares the driving information received by the second receiving unit with the information relating to the driving response and behavior estimated by the driving response estimating unit; and
an insurance premium setting unit which sets a premium to the driver based on a result of the comparison by the comparing unit.

18. An insurance premium setting terminal unit comprising:
a first obtaining unit which obtains at least either one of driving information for a driver of a vehicle, and position information that shows a position of the vehicle;
a first transmitting unit which transmits to a server at least either one of the driving information and the position information obtained by the first obtaining unit;
a first receiving unit which receives information relating to any one or both of driving response and behavior recommendable to the driver estimated by the server based on at least either one of the driving information and the position information transmitted from the first transmitting unit;
a warning unit which warns the driver based on the information relating to the driving response and behavior received by the first receiving unit;
a second obtaining unit which obtains driving information for the driver after the driver has been warned by the warning unit;
a second transmitting unit which transmits to the server the driving information obtained by the second obtaining unit; and
a second receiving unit which receives information relating to a premium to the driver set by the server based on the driving information transmitted from the second transmitting unit.
